(19) United States
(12) Patent Application Publication
(10) Pub. No.: US 2017/0337484 A1
(43) Pub. Date: Nov. 23, 2017

(54) SCALABLE WEB DATA EXTRACTION

(71) Applicant: HEWLETT PACKARD ENTERPRISE DEVELOPMENT LP, Houston, TX (US)

(72) Inventors: Xiaofeng Yu, Beijing (CN); Jun Qing Xie, Beijing (CN)

(21) Appl. No.: 15/532,982

(22) PCT Filed: Dec. 12, 2014
(86) PCT No.: PCT/CN2014/093670

§ 371 Date: Jun. 2, 2017

(51) Int. Cl. G06N 7/00; G06F 17/18; G06F 17/30

(52) U.S. Cl. CPC G06N 7/005; G06F 17/30864; G06F 17/18; G06F 17/30563; G06F 17/30604

(57) ABSTRACT

Example embodiments relate to scalable web data extraction. In example embodiments, a joint potential function is defined for data record segments of web data extracted from a web page, where the joint potential function models data record segmentation of the web data and dependencies between pairs of data segments in the data record segments. At this stage, a principal record segment and several related record segments are identified from the data record segments, where each of the plurality of related record segments is associated with the principal record segment. A related attribute is determined for each related record segment. Next, the joint potential function is applied to the principal record segment and each corresponding related segment to determine a relationship label that describes a data relationship between the principal record segment and the corresponding related segment.

### BACKGROUND

Various types of valuable semantic information are embedded in web pages. Web data extraction (e.g., web page text data segmentation and labeling, understanding of the semantics of web pages) can significantly improve a user's browsing and searching experience. Rule-based or pattern-based solutions may use text pattern matching such as regular expressions to identify small or specific structures or records from hypertext markup language (HTML) in web pages or use a template-based approach to identify common sections within a limited domain. These solutions mainly focus on page layout and format analysis using rule-based pattern mining approaches and are template-dependent such that they only work for web pages generated by the same template. Further, a user provides explicit information about each rule, pattern, template, etc. for rule-based or pattern-based solutions.

### BRIEF DESCRIPTION OF THE DRAWINGS

The following detailed description references the drawings, wherein:

FIG. 1 is a block diagram of an example computing device for providing scalable web data extraction;

FIG. 2 is a block diagram of an example computing device in communication with web servers for providing scalable web data extraction;

FIG. 3 is a flowchart of an example method for execution by a computing device for providing scalable web data extraction; and

FIG. 4 is a diagram of example relationship labels resulting from analysis of data record segments in web data.

### DETAILED DESCRIPTION

As detailed above, rule-based or pattern-based solutions may use text pattern matching such as regular expressions to identify small or specific structures or records from hypertext markup language (HTML). These solutions may use natural language processing and text analytics to analyze relationships between the text segments in HTML. However, because data contents of a web page are often text fragments and not strictly grammatical, traditional natural language processing (NLP) techniques, which typically expect grammatical sentences, are not directly applicable. The segmentation of logically coherent data blocks is non-trivial, and the text fragments within data blocks do not account for grammar. According, segmentation techniques usually remove or soften the boundaries of different text fragments. More importantly, most of the segmentation techniques remove structure formats of the HTML elements such as two-dimensional layout information and hierarchical organization, which results in reduced performance.

Examples herein describe a template-independent solution for efficient and scalable web data extraction that is based on a statistical framework with an arbitrary graphical structure. Such a solution is able to represent a large number of random variables as a family of probability distributions that factorize according to an underlying graph and capture complex dependencies between variables. For example in web data extraction from encyclopedic pages such as WIKIPEDIA®, each encyclopedic page has a major topic or concept represented by a principal data record such as “Abraham Lincoln”. A goal of this template-independent solution is to extract all the interested data records such as “Abraham Lincoln”, “February 12”, “1809”, and “Republican Party”, and assign attribute labels to these data records. In this example, the attribute labeling set can include pre-defined labels such as “person”, “date”, “year”, “organization” labels assigned to each data record and relationship labels such as “birth day”, “birth year”, and “member” between data record pairs. WIKIPEDIA® is a registered trademark of the Wikimedia Foundation, Inc., which is headquartered in San Francisco, Calif.

In some examples, a joint potential function is defined for data record segments of web data extracted from a web page, where the joint potential function models data record segmentation of the web data and dependencies between pairs of data segments in the data record segments. At this stage, a principal record segment and several related record segments are identified from the data record segments, where each of the plurality of related record segments is associated with the principal record segment. A related attribute is determined for each related record segment. Next, the joint potential function is applied to the principal record segment and each corresponding related segment to determine a relationship label that describes a data relationship between the principal record segment and the corresponding related segment.

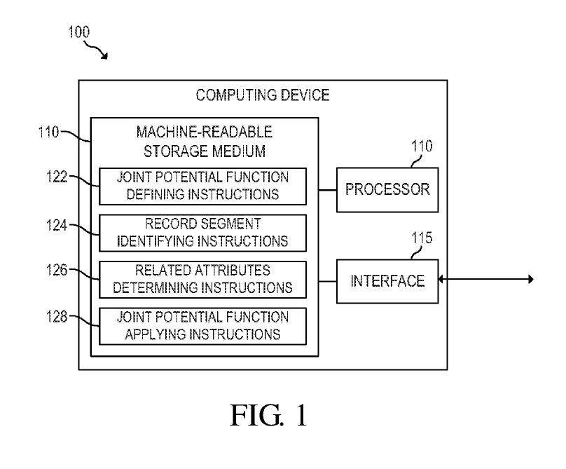

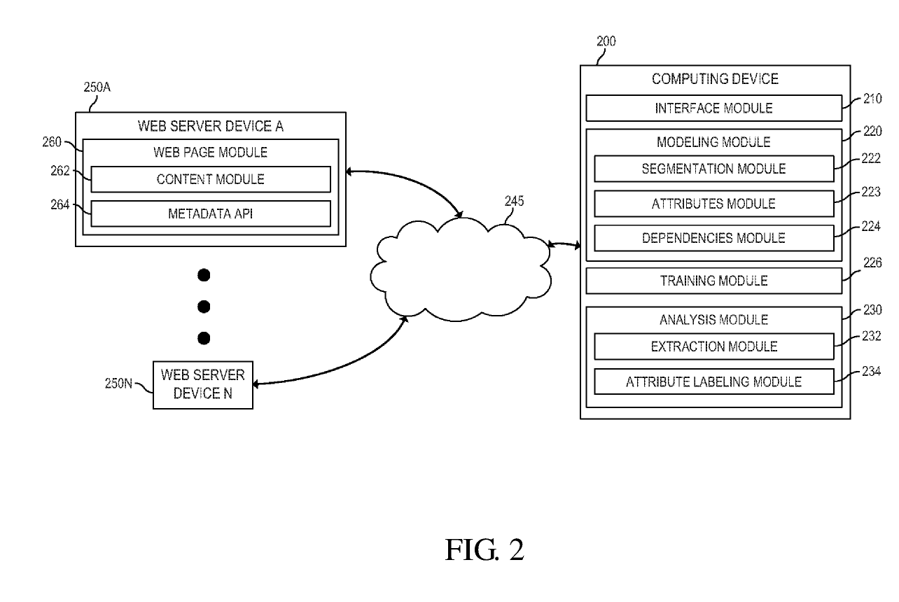

Referring now to the drawings, FIG. 1 is a block diagram of an example computing device 100 for providing scalable web data extraction. Computing device 100 may be any computing device capable of accessing web server devices, such as web server devices 250A, 250N of FIG. 2. In the embodiment of FIG. 1, computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable providing scalable web data extraction. As an alternative or in addition to retrieving and executing instructions, processor 110 may include one or more electronic circuits comprising a number of electronic components for performing the functionality of one or more of instructions 122, 124, 126, 128.

Interface 115 may include a number of electronic components for communicating with a web server device. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the web server device. Alternatively, interface 115 may be a wireless interface, such as a wireless local area network (WLAN) interface or a near-field communication (NFC) interface. In operation, as detailed below, interface 115 may be used to send and receive data to and from a corresponding interface of a web server device.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for providing scalable web data extraction.

Joint potential function defining instructions 122 defines a conditional distribution for data record segmentation in observation data and record attributes in undirected probabilistic, graphical models. The joint probability distribution of a Markov random field may be defined as a product of potential functions, where a potential function can be any non-negative function of its arguments. Data record segmentation is the segmentation of observation data from a web page into record segments (i.e., text fragments) that can then be analyzed as described below. Each record segment can be a word or a phrase that can be associated with an attribute.

For example, let L and M be the number of data record segments and number of attributes for web data x, respectively. In this example, a conditional distribution can be defined for data record segmentation s in observation data x and record attribute r in the undirected, probabilistic graphical models. The modeling enables partition of the factors C of G to be performed into three groups {C^{S},C^{R},C^{∇}}={{φ^{S}}, {φ^{R}}, {φ^{∇}}}, namely the data record segmentation potential φ^{S}, the attribute potential φ^{R}, and the record-attribute joint potential φ^{∇}, and each potential is a clique template whose parameters are tied. The potential function φ^{S}(i, s, x) models data record segmentation s in x, the potential function φ^{R}(rₚₘ, rₚₙ, r) (m≠n) represents dependencies (e.g., long-distance dependencies, relation transitivity, etc.) between any two attributes in the attribute labeling set r, where rₚₘ is the attribute assignment between the principal data record candidate sₚ (sₚ represents the major topic or concept of an encyclopedic page) and other data record candidate sₘ from s, and similarly for rₚₙ. Further, the joint potential φ^{∇}(sₚ, sⱼ, r) captures rich and complex interactions between data record segmentation s and record attribute r between data record pairs (e.g., between data record candidate sⱼ and the principal data record candidate sₚ). According to the Hammersley-Clifford theorem, the joint conditional distribution P(y/x)=P({r, s}/x) is factorized as a product of potential functions over cliques in the graph G as the form of an exponential family as shown below:

$$P ( y \vert x ) = \frac{1}{Z ( x )} ( {\prod }_{{C}_{S}}^{ } {φ}^{S} ( i , s , x ) ) ( {\prod }_{{C}_{R}}^{ } {φ}^{R} ( {r}_{pm} , {r}_{pn} , r ) ) ( {\prod }_{{C}_{∇}}^{ } {φ}^{∇} ( {s}_{p} , {s}_{j} , r ) )$$

### Where

Z(x)=Σ_{y}Π_{C}_{_{S}}φ^{S}(i, s, x)Π_{C}_{_{R}}φ^{R}(rₚₘ, rₚₙ, r)Π_{C}_{_{∇}}φ^{∇}(sₚ, sⱼ, r) is the normalization factor of the model. It is assumed that the potential functions φ^{S}, φ^{R} and φ^{∇} factorize according to a set of features and a corresponding set of real-valued weights. More specifically, φ^{S}(i, s, x)=exp(Σᵢ₌₁^{|s|}Σₖ₌₁^{K}λ_{kgk}(i, s, x)). To effectively capture properties of data record segmentation, the first-order Markov assumption is relaxed to semi-Markov such that each segment feature function gₖ(•) depends on the current segment the previous segment sᵢ₋₁, and the whole observation web data x, that is gₖ(i, s, x)=gₖ(sᵢ₋₁, sᵢ, x)=gₖ(yᵢ₋₁, yᵢ, αᵢ, βᵢ, x). Transitions within a segment can be non-Markovian.

Similarly, the potential φ^{R}(rₚₘ, rₚₙ, r)=exp(Σ_{m,n}^{M}Σ_{w=1}^{W}μ_{w}q_{w}(rₚₘ, rₚₙ, r)), where W and T are numbers of feature functions, q_{w}(•) and hₜ(•) are feature functions, μ_{w} and vₜ are corresponding weights for the functions. The potential φ^{R}(rₚₘ, rₚₙ, r) allows long-range dependency representation between different attributes rₚₘ and rₚₙ. For example, if the same data record is mentioned more than once in observation data, all mentions of the data record likely have the same relationship attribute for the principal data record. Using potential φ^{R}(rₚₘ, rₚₙ, r), associations for the same data record segments to the principal data record are shared among all their occurrences within the web data. The joint factor φ^{∇}(sₚ, sⱼ, r) exploits tight dependencies between record segmentations and attributes. For example, if a record segment is labeled as a “location” and the principal data record is “person”, the relationship attribute label between the records can be “birth place” or “visited”, but cannot be “employment”. Such dependencies are valuable and modeling them often leads to improved performance. In summary, the probability distribution of the above-mentioned framework can be rewritten as:

$$P ( y \vert x ) = \frac{1}{Z ( x )} exp \{ {\sum }_{i = 1}^{\vert s \vert} {\sum }_{k = 1}^{K} {λ}_{kgk} ( i , s , x ) + {\sum }_{m , n}^{M} {\sum }_{w = 1}^{W} {μ}_{w} {q}_{w} ( {r}_{pm} , {r}_{pn} , r ) + {\sum }_{j = 1}^{L} {\sum }_{t = 1}^{T} {v}_{t} {h}_{t} ( {s}_{p} , {s}_{j} , r ) \}$$

The model includes three sub-structures: a semi-Markov chain on the data record segmentations s conditioned on the observation web data x, represented by φ^{S}; potential φ^{R} measuring dependencies between different attributes rₚₘ and rₚₙ; and a fully-connected graph on the principal data record sₚ and each data record sⱼ for their attributes, represented by φ^{∇}. Various types of conditional random fields (CRFs) can be used in similar models. For example, linear-chain CRFs can only perform single sequence labeling because they lack the ability to capture long-distance dependency and represent complex interactions between multiple subtasks in web data extraction. In another example, skip-chain CRFs introduce skip edges to model long-distance dependencies to handle the label consistency issue in single sequence labeling and extraction. In yet another example, two dimensional (2D) CRFs incorporate the two-dimensional neighborhood dependencies in web pages; however, the graphical representation of this model is a 2D grid. The model of this figure may use hierarchical CRFs, which are a class of CRFs with hierarchical tree structure. The probabilistic model described above for efficient and scalable web has a distinct graphical structure from 2D and hierarchical CRFs. Further, the model uses semi-Markov chains for efficient data record segmentation and attribute labeling by representing long-range dependencies between attributes and by capturing rich and complex interactions between data record segmentation and attribute labeling to take advantage of mutual benefits.

Record segment identifying instructions 124 identifies a principal record segment and related record segments in the data record segmentation. In the example of an encyclopedic page, the principal record segment may be the topic of the page such as Abraham Lincoln. Related record segments may be identified as attributes that are syntactically or spatially related to the principal record segment. For example, the related record segments may be attributes in a sentence that refers to the principal record segment. The principal and related record segments are identified by analyzing the results of data record segmentation of observation data.

Related attributes determining instructions 126 determines attributes for the related record segments. For example, each related record segment can be classified as a “location”, “date”, “time”, etc. The attributes can be determined using text patterns such as regular expressions. Further, the attributes can be determined using look-up tables that have been populated by learning from sample datasets of web data.

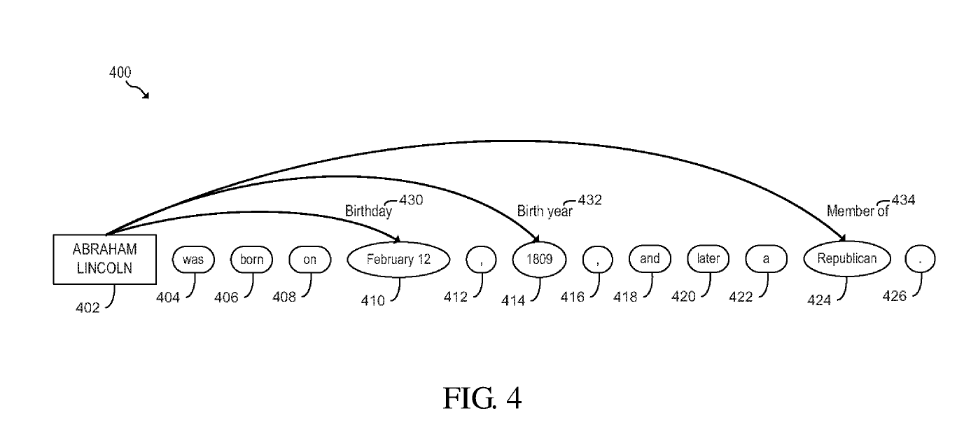

Joint potential function applying instructions 128 applies the joint potential function to the principal and related record segments to determine relationship attributes between pairs of record segments. Each relationship attribute describes the relationship between a principal record segment and a related record segment (e.g., birthplace, birth date, member of, etc.). The objective of inference is to find y*={r*, s*}=arg max_{{r,s}} P(r,s|x) such that both data record segmentation s* and attribute labeling r* are optimized simultaneously. Exact inference to this problem is generally prohibitive because it involves enumerating all possible segmentation and corresponding attribute labeling assignments. Consequently, approximate inference is used as an alternative. The joint potential function uses collective iterative classification (CIC) to perform approximate inference to determine the maximum a posteriori (MAP) data record segmentation and attribute labeling assignments in an iterative fashion. In short, CIC is used to decode every target hidden variable based on the assigning labels of its sampled variables, where the labels might be dynamically updated throughout the iterative process. Collective classification refers to the classification of relational objects described as nodes in a graphical structure as described below with respect to FIG. 4. The CIC algorithm performs inference in two steps (1) bootstrapping that predicts an initial labeling assignment for a unlabeled web data xᵢ given the trained model P(y/x) and (2) an iterative classification process that re-estimates the labeling assignment of xᵢ several times, picking the labeling assignments in a sample set S based on initial assignment for xi. In this case, sampling techniques are exploited that allow for a wide range of inference situations to be generated, and the samples are likely to be in high probability areas, which increasing the chances of finding the maximum and leading to more robust and accurate performance. The CIC algorithm may converge if none of the labeling assignments change during an iteration or a given number of iterations. Noticeably, the inference algorithm is also used to efficiently compute the marginal probability P(y/x) during parameter estimation (i.e., the normalization constant Z(x) can also be calculated via approximation techniques). This algorithm may be simple to design, efficient, and scalable with respect to the size of the web data.

FIG. 2 is a block diagram of an example computing device 200 for providing scalable web data extraction. Computing device 200 may be, for example, a computing device, a desktop computer, a rack-mount server, or any other computing device suitable for execution of the functionality described below. Computing device 200 is in communication with web server devices 250A, 250N via a network 245.

In the embodiment of FIG. 2, computing device 200 includes interface module 210, modeling module 220, training module 226, and analysis module 230. While computing device 200 may include a number of modules 210-234. Each of the modules may include a series of instructions encoded on a machine-readable storage medium and executable by a processor of computing device 200. In addition or as an alternative, each module may include one or more hardware devices including electronic circuitry for implementing the functionality described below.

Interface module 210 may manage communications with the web server devices 250A, 250N. Specifically, the interface module 210 may initiate connections with the web server devices 250A, 250N and then send or receive observation data to/from the web server devices 250A, 250N.

Modeling module 220 is configured to generate undirected probabilistic, graphical models for providing scalable web data extraction. Segmentation module 222 of modeling module 220 segments observation data into record segments. For example, if observation data is web data from a web page, segmentation module 222 may segment the web data in to words and phrases (i.e., record segments) that can be associated with attributes as described below with respect to the attributes module 223.

Attributes module 223 of modeling module 220 associates attributes with the record segments generated by segmentation module 222. Attribute labels for record segments include “person”, “date”, “year”, “organization”, etc. In some cases, attributes can be associated with record segments using text recognition such as regular expressions. Further, attributes can be associated with record segments based on look-up tables that have been generated based on sample datasets of observation data.

Dependencies module 224 of modeling module 220 identifies dependencies between record segments. Dependencies may include long-distance dependencies, transitive relations, etc. Specifically, dependencies module 224 can identify dependencies between a principal record segment and related record segments in the observation data. In some cases, the dependencies may be identified based on the attributes associated with the principal and related record segments. The dependencies may be similar to the dependencies discussed below with respect to FIG. 4.

Training module 226 is configured to train the models generated by modeling module 220. Given independent and identically distributed (IID) training web data [symbol] ={xⁱ, yⁱ}ᵢ₌₁^{N}, where xⁱ is the i-th data instance and yⁱ={rⁱ, sⁱ} is the corresponding data record segmentation and attribute labeling assignments. The objective of learning is to estimate Λ={λₖ, μ_{w}, vₜ}, which is the vector of the model's parameters. Under the IID assumption, the summation operator Σᵢ₌₁ [symbol] is ignored in the log-likelihood during the following derivations. To reduce over-fitting, regularization such as a spherical Gaussian prior with zero mean and covariance σ²l can be used. Then the regularized log-likelihood function L for the data can be expressed as:

$$ℒ = log [ Φ ( r , s , x ) ] - log [ Z ( x ) ] - {\sum }_{k = 1}^{K} \frac{{λ}_{k}^{2}}{2 {σ}_{λ}^{2}} - {\sum }_{w = 1}^{W} \frac{{μ}_{w}^{2}}{2 {σ}_{μ}^{2}} - {\sum }_{t = 1}^{T} \frac{{ν}_{t}^{2}}{2 {σ}_{ν}^{2}}$$

### Where

Φ(r, s, x)=exp{Σᵢ₌₁^{|s|}Σₖ₌₁^{K}λ_{kgk}(i, s, x)+Σ_{m,n}^{M}Σ_{w=1}^{W}μ_{w}q_{w}(rₚₘ, rₚₙ, r)+Σⱼ₌₁^{L}Σₜ₌₁^{T}vₜhₜ(sₚ, sⱼ, r)}, Z(x)=Σ_{y}ΠΦ(r, s, x), and 1/2σ_{λ}², 1/2σ_{μ}², 1/2σᵥ² are regularization parameters. Taking derivatives of the function [symbol] over the parameter λₖ yields:

$$\frac{\partial ℒ}{\partial {λ}_{k}} = {\sum }_{i = 1}^{\vert s \vert} {g}_{k} ( i , s , x ) - {\sum }_{i = 1}^{\vert s \vert} {g}_{k} ( i , s , x ) P ( y \vert x ) - {\sum }_{k = 1}^{K} \frac{{λ}_{k}}{{σ}_{λ}^{2}}$$

Similarly, the partial derivatives of the log-likelihood with respect to parameters μ_{w} and vₜ are as follows:

$$\frac{\partial ℒ}{\partial {μ}_{w}} = {\sum }_{m , n}^{M} {q}_{w} ( {r}_{pm} , {r}_{pn} , r ) - {\sum }_{m , n}^{M} {q}_{w} ( {r}_{pm} , {r}_{pn} , r ) P ( y \vert x ) - {\sum }_{w = 1}^{W} \frac{{μ}_{w}}{{σ}_{μ}^{2}}$$

$$\frac{\partial ℒ}{\partial {ν}_{t}} = {\sum }_{j = 1}^{L} {h}_{t} ( {s}_{p} , {s}_{j} , r ) - {\sum }_{j = 1}^{L} {h}_{t} ( {s}_{p} , {s}_{j} , r ) P ( y \vert x ) - {\sum }_{t = 1}^{T} \frac{{ν}_{t}}{{σ}_{ν}^{2}}$$

The function [symbol] is concave and can be efficiently maximized by standard techniques such as stochastic gradient and limited memory quasi-Newton (L-BFGS) algorithms. The parameters λₖ, μ_{w}, and vₜ are optimized iteratively until convergence.

Analysis module 230 applies the model generated by modeling module 220 to the observation data to determine relationship labels between record segments. Extraction module 232 of analysis module 230 is configured to extract observation data (i.e., web data) from the web server devices 250A, 250N. Specifically, extraction module 230 may use the interface module 232 to obtain web data from a web server device (e.g., web server device A 250A, web server device N 250N, etc.). The web data is associated with a web page provided by the web server device (e.g., web server device A 250A, web server device N 250N, etc.) and can be in various formats such as hypertext markup language (HTML). Further, extraction module 232 may also obtain metadata that describes the web data from the web server device (e.g., web server device A 250A, web server device N 250N, etc.). Examples of metadata include a list of tools used to create the web page, keywords, time and date the web page was created, etc.

Attribute labeling module 234 applies the model generated by modeling module 220 to principal and related record segments identified by the dependencies module 224 to determine attribute labels for record segment pairs. Specifically, a joint potential function in the model can be applied to the principal record segment and each related record segment to determine the relationship between the pair. For example, if the principal record segment has been assigned a “person” attribute and the related record segment has been assigned a “location” attribute, attribute labeling module may determine that a “birthplace” relationship label should be applied to the pair of record segments. The “birthplace” relationship label describes the relationship between the pair of record segments as a rich dependency in the web data that can be automatically identified using the model.

Web server devices 250A, 250N may be any servers accessible to computing device 200 over a network 245 that is suitable for executing the functionality described below. As detailed below, each web server device 250A, 250N may include a series of modules 260-264 for providing web content.

Web page module 260 is configured to provide access to web pages of web server device A 250A. Content module 262 of web page module 260 is configured to serve the web pages as web content over the network 245. The web pages can be provided as HTML pages that are configured to be displayed in web browsers. In this case, server computer device 200 obtains the HTML pages from the content module 262 for processing as web data as described above.

Metadata API 264 of web page module 260 manages metadata related to the web pages. The metadata describes the web data and can be included in the web pages provided by the content module 262. For example, keywords describing various page elements can be embedded as metadata in the web pages.

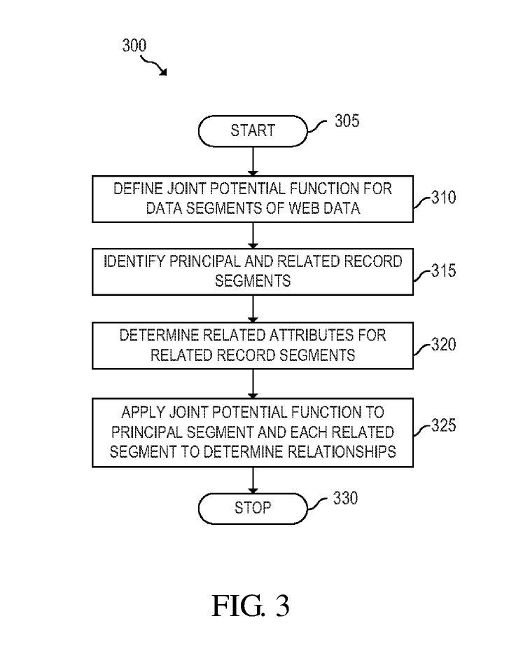

FIG. 3 is a flowchart of an example method 300 for execution by a computing device 100 for providing scalable web data extraction. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 defines a conditional distribution for data record segmentation in observation data and record attributes in undirected probabilistic, graphical models. In block 315, a principal record segment and related record segments are identified in the data record segmentation. The principal and related record segments are identified by analyzing the results of the data record segmentation of observation data. For example, the sequence of data record segments (i.e., context of each record segment) can be analyzed in view of the complete set of web data.

In block 320, computing device 100 determines attributes for the related record segments. For example, the attributes can be determined using text patterns such as regular expressions. In block 325, computing device 100 applies the joint potential function to the principal and related record segments to determine relationship attributes between pairs of record segments. Each relationship attribute describes the relationship between a principal record segment and a related record segment (e.g., birthplace, birth date, member of, etc.). Method 300 may then continue to block 330, where method 300 may stop.

FIG. 4 is a diagram 400 of example relationship labels resulting from analysis of data record segments in web data. The diagram 400 shows record segments 402-426 with identified relationship labels 430-434. The record segments 402-426 include a principal record segment 402 and related record segments 410, 414, 424. In this example, the principal record segment 402, “Abraham Lincoln” may be the topic of an encyclopedic web page. The related record segments 410, 414, 424 are shown to have relationships 430, 432, 434 with the principal record segment 402.

The related record segments 410, 414, 424 may each be associated with an attribute, which in this example may be “date” for related record segment 410, “year” for related record segment 414, and “group” for related record segment 424. The principal record segment 402 may be associated with a “person” attribute. When applying a model as described above with respect to FIGS. 1-3, the principal record segment 402 can be analyzed with each related record segment 410, 414, 424 to determine the relationship labels 430-434.

For related record segment 410, the model determines that the principal record segment 402 “person” is related to “date” as a “birthday”, which is shown in relationship 430. For related record segment 414, the model determines that the principal record segment 402 “person” is related to “year” as a “birth year”, which is shown in relationship 432. For related record segment 424, the model determines that the principal record segment 402 “person” is related to “group” as a “member of”, which is shown in relationship 434.

The foregoing disclosure describes a number of example embodiments for providing scalable web data extraction by a computing device. In this manner, the embodiments disclosed herein enable providing scalable web data extraction by using a probabilistic model that accounts for the statistical attributes of record segments in the web data.

1. A computing device for scalable web data extraction, the computing device comprising:
a processor to:
define a joint potential function for a plurality of data record segments of web data extracted from a web page, wherein the joint potential function models data record segmentation of the web data and dependencies between pairs of data segments in the plurality of data record segments;
identify a principal record segment and a plurality of related record segments from the plurality of data record segments, wherein each of the plurality of related record segments is associated with the principal record segment;
determine a plurality of related attributes, wherein each attribute of the plurality of related attributes is associated with a corresponding related segment of the plurality of related record segments; and
apply the joint potential function to the principal record segment and each corresponding related segment to determine a corresponding relationship label that describes a data relationship between the principal record segment and the corresponding related segment.

2. The computing device of claim 1, wherein the joint potential function is trained using at least one of a stochastic gradient and a limited memory quasi-Newton algorithm, and wherein the joint potential function is concave.

3. The computing device of claim 2, wherein the joint potential function is defined as
$$ℒ = log [ Φ ( r , s , x ) ] - log [ Z ( x ) ] - {\sum }_{k = 1}^{K} \frac{{λ}_{k}^{2}}{2 {σ}_{λ}^{2}} - {\sum }_{w = 1}^{W} \frac{{μ}_{w}^{2}}{2 {σ}_{μ}^{2}} - {\sum }_{t = 1}^{T} \frac{{ν}_{t}^{2}}{2 {σ}_{ν}^{2}} ,$$
and wherein
Φ(r, s, x)=exp{Σᵢ₌₁^{|s|}Σₖ₌₁^{K}λ_{kgk}(i, s, x)+Σ_{m,n}^{M}Σ_{w=1}^{W}μ_{w}q_{w}(rₚₘ, rₚₙ, r)+Σⱼ₌₁^{L}Σᵢ₌₁^{T}vₜhₜ(sₚ, sⱼ, r)}, Z(x)=Σ_{y}ΠΦ(r, s, x), and 1/2σ_{λ}², 1/2σ_{μ}², 1/2σᵥ² are regularization parameters and s is an assignment of data record segmentation, r is an assignment of attribute labeling, x is the web data, and λₖ, μ_{w}, vₜ are parameters for optimization in a probabilistic model that includes the joint potential function.

4. The computing device of claim 1, wherein the joint potential function comprises a semi-Markov assumption for determining the data record segmentation such that each segment feature function depends on a current record segment, a previous record segment, and a comprehensive observation of the web data.

5. The computing device of claim 1, wherein the joint potential function is included in a probabilistic model that is defined as
$$P ( y \vert x ) = \frac{1}{Z ( x )} ( {\prod }_{{C}_{S}}^{ } {φ}^{S} ( i , s , x ) ) ( {\prod }_{{C}_{R}}^{ } {φ}^{R} ( {r}_{pm} , {r}_{pn} , r ) ) ( {\prod }_{{C}_{∇}}^{ } {φ}^{∇} ( {s}_{p} , {s}_{j} , r ) ) ,$$
and wherein Z(x) is a normalization factor, φ^{S} is a record segmentation potential function, φ^{R} is an attribute potential function, φ^{∇} is the joint potential function, s is an assignment of data record segmentation, and r is an assignment of attribute labeling.

6. A method for scalable web data extraction, the method comprising:
defining a joint potential function in a probabilistic model for a plurality of data record segments of web data extracted from a web page, wherein the joint potential function is concave and models data record segmentation of the web data and dependencies between pairs of data segments in the plurality of data record segments;
identifying a principal record segment and a plurality of related record segments from the plurality of data record segments, wherein each of the plurality of related record segments is associated with the principal record segment;
determining a plurality of related attributes, wherein each attribute of the plurality of related attributes is associated with a corresponding related segment of the plurality of related record segments; and
applying the joint potential function to the principal record segment and each corresponding related segment to determine a corresponding relationship label that describes a data relationship between the principal record segment and the corresponding related segment.

7. The method of claim 6, wherein the joint potential function is trained using at least one of a stochastic gradient and a limited memory quasi-Newton algorithm.

8. The method of claim 7, wherein the joint potential function is defined as
$$ℒ = log [ Φ ( r , s , x ) ] - log [ Z ( x ) ] - {\sum }_{k = 1}^{K} \frac{{λ}_{k}^{2}}{2 {σ}_{λ}^{2}} - {\sum }_{w = 1}^{W} \frac{{μ}_{w}^{2}}{2 {σ}_{μ}^{2}} - {\sum }_{t = 1}^{T} \frac{{ν}_{t}^{2}}{2 {σ}_{ν}^{2}} ,$$
and wherein
Φ(r, s, x)=exp{Σᵢ₌₁^{|s|}Σₖ₌₁^{K}λ_{kgk}(i, s, x)+Σ_{m,n}^{M}Σ_{w=1}^{W}μ_{w}q_{w}(rₚₘ, rₚₙ, r)+Σⱼ₌₁^{L}Σₜ₌₁^{T}vₜhₜ(sₚ, sⱼ, r)}, Z(x)=Σ_{y}ΠΦ(r, s, x), and 1/2σ_{λ}², 1/2σ_{μ}², 1/2σᵥ² are regularization parameters and s is an assignment of data record segmentation, r is an assignment of attribute labeling, x is the web data, and λₖ, μ_{w}, vₜ are parameters for optimization in the probabilistic model.

9. The method of claim 6, wherein the joint potential function comprises a semi-Markov assumption for determining the data record segmentation such that each segment feature function depends on a current record segment, a previous record segment, and a comprehensive observation of the web data.

10. The method of claim 6, wherein the probabilistic model is defined as
$$P ( y \vert x ) = \frac{1}{Z ( x )} ( {\prod }_{{C}_{S}}^{ } {φ}^{S} ( i , s , x ) ) ( {\prod }_{{C}_{R}}^{ } {φ}^{R} ( {r}_{pm} , {r}_{pn} , r ) ) ( {\prod }_{{C}_{∇}}^{ } {φ}^{∇} ( {s}_{p} , {s}_{j} , r ) ) ,$$
and wherein Z(x) is a normalization factor, φ^{S} is a record segmentation potential function, φ^{R} is an attribute potential function, φ^{∇} is the joint potential function, s is an assignment of data record segmentation, and r is an assignment of attribute labeling.

11. A non-transitory machine-readable storage medium encoded with instructions executable by a processor for providing scalable web data extraction, the machine-readable storage medium comprising instructions to:
define a joint potential function for a plurality of data record segments of web data extracted from a web page, wherein the joint potential function models data record segmentation of the web data and dependencies between pairs of data segments in the plurality of data record segments, and wherein the joint potential function is trained using at least one of a stochastic gradient and a limited memory quasi-Newton algorithm;
identify a principal record segment and a plurality of related record segments from the plurality of data record segments, wherein each of the plurality of related record segments is associated with the principal record segment;
determine a plurality of related attributes, wherein each attribute of the plurality of related attributes is associated with a corresponding related segment of the plurality of related record segments; and
apply the joint potential function to the principal record segment and each corresponding related segment to determine a corresponding relationship label that describes a data relationship between the principal record segment and the corresponding related segment.

12. The non-transitory machine-readable storage medium of claim 11, wherein the joint potential function is concave.

13. The non-transitory machine-readable storage medium of claim 12, wherein the joint potential function is defined as
$$ℒ = log [ Φ ( r , s , x ) ] - log [ Z ( x ) ] - {\sum }_{k = 1}^{K} \frac{{λ}_{k}^{2}}{2 {σ}_{λ}^{2}} - {\sum }_{w = 1}^{W} \frac{{μ}_{w}^{2}}{2 {σ}_{μ}^{2}} - {\sum }_{t = 1}^{T} \frac{{ν}_{t}^{2}}{2 {σ}_{ν}^{2}} ,$$
and wherein
Φ(r, s, x)=exp{Σᵢ₌₁^{|s|}Σₖ₌₁^{K}λ_{kgk}(i, s, x)+Σ_{m,n}^{M}Σ_{w=1}^{W}μ_{w}q_{w}(rₚₘ, rₚₙ, r)+Σⱼ₌₁^{L}Σₜ₌₁^{T}vₜhₜ(sₚ, sⱼ, r)}, Z(x)=Σ_{y}ΠΦ(r, s, x), and 1/2σ_{λ}², 1/2σ_{μ}², 1/2σᵥ² are regularization parameters and s is an assignment of data record segmentation, r is an assignment of attribute labeling, x is the web data, and λₖ, μ_{w}, vₜ are parameters for optimization in a probabilistic model that includes the joint potential function.

14. The non-transitory machine-readable storage medium of claim 11, wherein the joint potential function comprises a semi-Markov assumption for determining the data record segmentation such that each segment feature function depends on a current record segment, a previous record segment, and a comprehensive observation of the web data.

15. The non-transitory machine-readable storage medium of claim 11, wherein the joint potential function is included in a probabilistic model that is defined as
$$P ( y \vert x ) = \frac{1}{Z ( x )} ( {\prod }_{{C}_{S}}^{ } {φ}^{S} ( i , s , x ) ) ( {\prod }_{{C}_{R}}^{ } {φ}^{R} ( {r}_{pm} , {r}_{pn} , r ) ) ( {\prod }_{{C}_{∇}}^{ } {φ}^{∇} ( {s}_{p} , {s}_{j} , r ) ) ,$$
and wherein Z(x) is a normalization factor, φ^{S} is a record segmentation potential function, φ^{R} is an attribute potential function, φ^{∇} is the joint potential function, s is an assignment of data record segmentation, and r is an assignment of attribute labeling.
